(19) United States
(12) Patent Application Publication
(10) Pub. No.: US 2006/0060765 A1
(43) Pub. Date: Mar. 23, 2006

(54) PHOTOSENSITIVE BONDING PACKAGE STRUCTURE

(76) Inventor: Tai-Yuan Huang, Kaohsiung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,729

(22) Filed: Sep. 21, 2005

(30) Foreign Application Priority Data
Sep. 21, 2004 (TW) 93128512

(51) Int. Cl. H01J 40/14

(52) U.S. Cl. 250/239

(57) ABSTRACT

A photosensitive bonding package structure mainly comprising a substrate, a photosensitive device and a plurality of bumps is provided. The substrate has a light incident area located near the central area of the substrate. The photosensitive device has a photosensitive area in a position corresponding to the light incident area so that the photosensitive device can receive a beam of incident light passing through the opening. In addition, the substrate has a plurality of inner contacts and corresponding outer contacts. Pads on the photosensitive device are connected to the inner contacts through bumps so that the electrical signals resulting from illuminating the photosensitive area is transmitted to the substrate.

### CROSS-REFERENCE TO RELATED APPLICATION

This application claims the priority benefit of Taiwan application serial no. 93128512, filed on Sep. 21, 2005. All disclosure of the Taiwan application is incorporated herein by reference.

### BACKGROUND OF THE INVENTION

1. Field of the Invention

The present invention relates to a chip package structure. More particularly, the present invention relates to a photosensitive bonding package structure.

2. Description of the Related Art

With the rapid progress in electronic packaging techniques, a variety of semiconductor packages has been developed. It is now common to sent finished photosensitive chips (or wafers) to a wafer packaging facility for additional processing operations including wafer cutting, die attaching, curing, wire bonding, molding, ball implant and substrate loading. Finally, the finished products are quality inspected or functionally tested to ensure a good reliability. Since the packaged photosensitive chip can integrate with other control circuits, analogue-to-digital (A/D) converters and digital processing signals, the production cost of these photosensitive packages has dropped considerably. Furthermore, these photosensitive packages often have a light, streamlined and compact design so that they can be carried around with ease.

In general, photosensitive devices (or image-detecting devices) can be classified into two major categories: a charge-coupled device (CCD) or a complementary metal-oxide-semiconductor (CMOS) device. Both the CCD image-sensing device and the CMOS image-sensing device have an array of photodiodes located within an illumination area. The array of photodiodes is designed to receive external image signals (or light intensity signals) and convert the image signal into electrical signals so that the electrical signals can be transmitted to a circuit substrate for additional image processing.

FIG. 1 is a schematic cross-sectional view of a conventional photosensitive chip package. As shown in FIG. 1, the chip package structure 100 mainly comprises a circuit substrate 110, a photosensitive device 120 and a sealing frame 130. The photosensitive device 120 is, for example, a CCD image-sensing device or a CMOS image-sensing device disposed on as well as electrically connected to the circuit substrate 110. To prevent the photosensitive region 122 of the photosensitive device 120 from contamination by impurities or micro-particles, the photosensitive device 120 is entirely enclosed using the sealing frame 130. The sealing frame 130 can be fabricated from a number of materials including transparent glass or acrylic. The light emitting from an image of an external light beam can easily penetrate through the sealing frame 130 to reach the photosensitive region 122 of the photosensitive device 120. Because an array of photodiodes (not shown) inside the photosensitive device 120 can convert image signals into electrical signals and transmit the signals via the circuit substrate 110 to an external image-processing chip (not shown), the flux intensity and the degree of color saturation in each pixel is obtained.

It should be noted that the photosensitive device 120 is electrically connected to the circuit substrate 110 through bonding wires. Hence, aside from reserving an area for attaching the photosensitive device 120, additional area must be reserved for accommodating the bonding wires. Due to the need for accommodating bonding wires, the chip package 100 needs to have a larger substrate area. In other words, overall volume of the packaged photosensitive device 120 is increased. Furthermore, the height of the sealing frame 130 is constrained by the bonding wires to a height at least as great as the height of the wires, thereby increasing the volume of the package even more. These two factors together ultimately set the minimum width and vertical height of the packaged photosensitive device 120.

### SUMMARY OF THE INVENTION

Accordingly, at least one objective of the present invention is to provide a photosensitive bonding package structure whose circuit substrate has an area almost equal the area occupied by the photosensitive region of a photosensitive device. Thus, the horizontal width and area of the packaged photosensitive device is reduced.

At least a second objective of the present invention is to provide a photosensitive bonding package structure such that the vertical height of the packaged photosensitive device is reduced. Hence, the volume of the package is reduced.

To achieve these and other advantages and in accordance with the purpose of the invention, as embodied and broadly described herein, the invention provides a photosensitive bonding package structure mainly comprising a photosensitive device, a circuit substrate and a plurality of bumps. The photosensitive device has an active surface. The active surface has a photosensitive region and a plurality of bonding pads. The bonding pads are disposed around the photosensitive region. In addition, the circuit substrate has a light incident area in a position corresponding to the photosensitive region. The circuit substrate further comprises a plurality of inner contacts and a corresponding number of outer contacts. The inner contacts are disposed on the surface of the circuit substrate around the light incident area. The inner contacts are electrically connected to corresponding outer contacts. The bumps are disposed between the circuit substrate and the photosensitive device such that each bump connects a bonding pad with a corresponding inner contact.

According to one preferred embodiment of the present invention, the circuit substrate can be a flexible circuit board, a printed circuit board, a ceramic substrate or a plastic substrate. The purpose of forming the light incident area is to permit the passage of a light beam through a designated area into the photosensitive region while the non-transparent area (the area outside the light incident area) blocks off the remaining light beam.

According to one preferred embodiment of the present invention, the photosensitive device can be a charge-coupled device (CCD) or a complementary metal-oxide-semiconductor (CMOS) device. The photosensitive device is electrically connected to the circuit substrate by bonding using bumps. The bumps are fabricated using tin/lead alloy, gold or other conductive materials, for example. One of the advantages of having a bonding is that the vertical height of the photosensitive device can be reduced considerably.

The present invention also provides an alternative photosensitive bonding package structure mainly comprising a photosensitive device, a transparent substrate and plurality of bumps. The photosensitive device has a photosensitive region and a plurality of bonding pads. The bonding pads are disposed on the photosensitive device around the photosensitive region. In addition, the transparent substrate has a transparent region that corresponds to the photosensitive region. The transparent substrate also has a plurality of inner contacts and a plurality of corresponding outer contacts. The inner contacts are disposed on the transparent substrate around the transparent region. Furthermore, the inner contacts are electrically connected to corresponding outer contacts. The bumps are disposed between the transparent substrate and the photosensitive device such that each bump electrically connects a bonding pad with a corresponding inner contact.

The present invention also provides yet another bonding package structure mainly comprising a circuit substrate, an optical pick-up device and a plurality of bumps. The circuit substrate has a light incident area located in the central region of the circuit substrate. Furthermore, the optical pick-up device has a light source located in a position corresponding to the light incident area so that a beam of light can emerge from the light incident area. The circuit board also has a plurality of inner contacts and a plurality of corresponding outer contacts on the circuit substrate. The inner contacts are electrically connected to the bonding pads of the optical pick-up device through the bumps so that optical data can be read, erased or programmed.

The package structure of the present invention utilizes a circuit substrate having a light incident area so that only a portion of an external light beam can get through to the photosensitive device inside the package. Furthermore, the beam of light passing through the light incident area is captured and converted into an electrical signal through the photosensitive device and transmitted to the circuit substrate. Hence, compared with a conventional photosensitive chip package structure, the aforementioned circuit substrate and the bonded photosensitive device together form a package structure occupying a smaller volume and having a higher level of integration.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional photosensitive chip package.

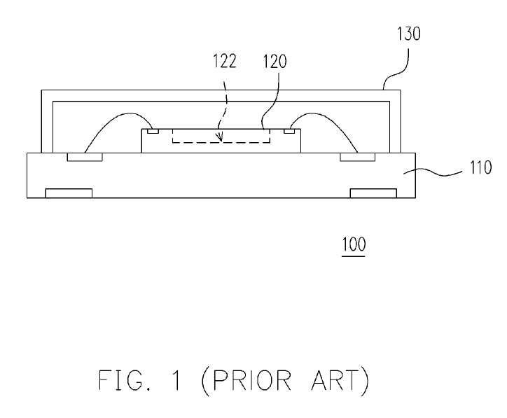

FIGS. 2 and 3 are schematic cross-sectional views showing a split-up and an assembled photosensitive bonding package according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

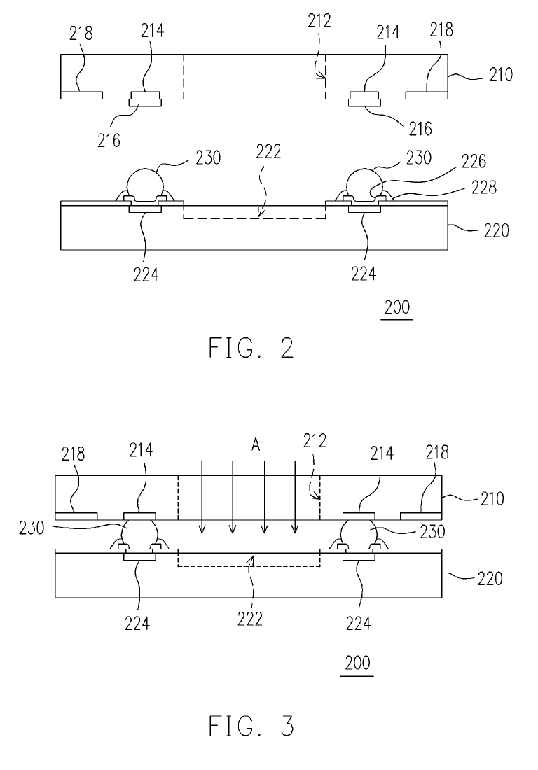

FIGS. 2 and 3 are schematic cross-sectional views showing a split-up and an assembled photosensitive bonding package according to one preferred embodiment of the present invention. As shown in FIG. 2, a circuit substrate 210 with a light incident area 212 is positioned above a photosensitive device 220. Thereafter, as shown in FIG. 3, the circuit substrate 210 is aligned with a plurality of bumps 230 on the photosensitive device 220 so that the two are electrically connected to form a photosensitive bonding package structure.

Before assembling the circuit substrate 210 and the photosensitive device 220 together, a light incident area 212 formed in the circuit substrate 210 is fabricated. The circuit substrate 210 is a flexible circuit board (having a single circuit layer or multiple circuit layers), a printed circuit board, a glass substrate, a ceramic substrate or a plastic substrate, for example. Aside from special requirements, the light incident area 212 is disposed in the central region of the circuit board 210. The light incident area 212 is formed as an opening by a punching or a cutting process, an etching process or using some form of boring technique, for example. The purpose of the light incident area 212 in the circuit substrate 210 is to guide the effective portion of a light beam through the transparent area into the photosensitive region 222 and deflect the remaining portion (or any stray light) via the non-transparent area outside the light incident area 212. Obviously, the size of the light incident area 212 will affect the flux of light reaching the photosensitive region 222 of the photosensitive device 220. Therefore, the area of the light incident area 212 is preferably larger than the effective area of the photosensitive region 222.

The light incident area 212 in the circuit substrate 210 may be sealed by a glass plate (not shown) or a transparent film. The purpose of the seal is toprevent impurities and micro-particles from depositing on the photosensitive region 222 through the light incident area 212 so that the degree of contamination and dust particle accumulation on the surface of the photosensitive region 222 is minimized. Obviously, to enhance the desired qualities of the light incident area 212 (for example, to increase the light collimating power, reduce reflection or prevent dispersion), special material or special processing steps may be included. In addition, if the circuit substrate 210 deploys a transparent dielectric material (for example, glass), which only has to define a special “light incident area” above the photosensitive region 222 to serve as a transparent region. In other words, the steps for fabricating the light incident area can be deleted.

To reduce material cost, the horizontal width of the circuit substrate 210 after cutting should be roughly equivalent to the width of the photosensitive device 220. Furthermore, there should not be too much difference between the horizontal width (entire body) of the packaged photosensitive device 220 and the width of the original photosensitive device 222. In other words, the horizontal width of the photosensitive device 220 is little affected by the circuit substrate 210. That means, the horizontal width of the packaged photosensitive device 220 will not differ too much from the width of the original photosensitive device 222. This is a major improvement in the photosensitive chip package 200.

Similarly, before assembling the circuit substrate 210 and the photosensitive device 220 together, the photosensitive device 220 is fabricated in a semiconductor process. This includes fabricating an array of photodiodes (not shown) on a silicon wafer, defining the active surface of the photosensitive region 222 and the locations of the bonding pads 224 so that light falling on the photosensitive region 222 is converted into electrical signals through the photodiodes. The photosensitive device 220 is a charge-coupled device (CCD) or a complementary metal-oxide-semiconductor (CMOS) device, for example. The bonding pads 224 (only two of them are shown) of the photosensitive device 220 are disposed around the photosensitive region 222 such that each bonding pad 224 corresponds to an inner contact 214 on the circuit substrate 210.

It should be noted that the photosensitive device 220 and the circuit substrate 210 in the present invention are electrically connected through bumps 230 in a bonding process instead or a conventional wire bonding process. The bonding process includes forming a patterned passivation layer 226 over the photosensitive device 220 to expose the bonding pads 224 and the photosensitive region 222. Thereafter, an under-ball metallurgic (UBM) layer 226 and lead-tin solder material are sequentially fabricated over each bonding pad 224. A reflow process is carried out to convert the lead-tin solder material into spherical bumps as shown in FIG. 2. Obviously, the bumps 230 can be fabricated using other conductive materials beside lead-tin solder material. Furthermore, the method of fabricating the bumps 230 is not limited to the one described. In addition, to increase the spherical size of the bumps 230 and strengthen the spherical structure, a high molecular weight polymer 228 (for example, epoxy resin, polyimide and so on) can be optionally formed to enclose the bumps 230.

As shown in FIG. 3, the circuit substrate 210 with the light incident area 212 and the photosensitive device 220 with the bumps 230 are bonded to form a photosensitive bonding package. Because the present invention does not have a sealing frame 130 or need to reserve space for accommodating the height of the bonding wires, the height of the package is only slightly larger than the combined thickness of the circuit substrate 210, the bumps 230 and the photosensitive device 220. This is one major improvement of the photosensitive chip package structure in the present invention. With the maturity of packaging technique, the method in the present invention can be applied to wafer level chip packages to increase package performance and meet the needs of future market demands.

In signal transmission, the inner contacts 214 on the circuit substrate 210 are electrically connected to the bumps 230 on the bonding pads 224 through pre-solder blocks 216. Hence, incident light A or image light passing through the light incident area 212 can be converted into electrical signals by the photosensitive device 220 and subsequently transmitted to the inner contacts 214 of the circuit substrate 210 via the bonding pads 224. Thereafter, the signals are transmitted from the inner contacts 214 to corresponding outer contacts 218. The outer contacts 218 can have a number of configurations such as solder balls, pins, leads or other transmission interfaces for electrically connecting with an external control circuit, for example, an image-signal processing circuit or an analog/digital circuit. In the present invention, the outer contacts 218 and the inner contacts 214 can be located on the same side of the circuit substrate 210 or on two terminal regions of the circuit defined in the same photolithographic and etching process. In general, the outer contacts 218 are located near the outer edges of the circuit substrate 210. Obviously, the outer contacts 218 and the inner contacts 214 can be disposed on the top, the bottom or an interior surface (not shown) of the circuit substrate 210. Thus, any modification in the organization or method of fabrication of the outer contacts and inner contacts should be considered as within the scope of the present invention.

The package structure 200 of the present invention utilizes the light incident area 212 (or window) on the circuit substrate 210 to serve as a light shield and a light guide. Hence, a portion of the incident light can pass through the light incident area 212 and captured by the photosensitive device 220 bonded to the circuit substrate 210. After converting the light energy into electrical signals, the signals are transmitted back to the circuit substrate 210 for subsequent image processing operations. In addition, the package structure of the present invention can also be applied to form other miniature optical data pick-up heads or optically programmable, readable/writable or erasable memory devices (EPROM) package. These device packages have a very similar structure. The only difference is that an optical device is installed to produce a light beam passing through the light incident area 212 (or window) of the circuit substrate 210 rather than the photosensitive device 220 capturing any incident light passing through the light incident area 212. Similarly, the horizontal width and the vertical height of the miniature optical device package are reduced so that the optical package can occupy a smaller volume and have a higher level of integration.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A photosensitive bonding package structure, comprising:
a photosensitive device having an active surface, wherein the active surface has a photosensitive region and a plurality of bonding pads disposed around the photosensitive region;
a circuit substrate having a light incident area disposed over the photosensitive region, wherein the circuit substrate has a plurality of inner contacts and a plurality of corresponding outer contacts, the inner contacts are disposed around the light incident area and electrically connected with corresponding outer contacts; and
a plurality of bumps disposed between the circuit substrate and the photosensitive device, wherein each bump connect one of the bonding pads with a corresponding inner contact.

2. The photosensitive bonding package structure of claim 1, wherein the inner contacts and the outer contacts are disposed on the same surface of the circuit substrate such that the outer contacts are disposed close to the outer edge of the circuit substrate.

3. The photosensitive bonding package structure of claim 1, wherein the light incident area is disposed in the central region of the circuit substrate.

4. The photosensitive bonding package structure of claim 1, wherein the inner contacts and the outer contacts are disposed on the top and the bottom surface of the circuit substrate and they are electrically connected through an internal circuit within the circuit substrate.

5. The photosensitive bonding package structure of claim 1, wherein the circuit substrate is selected from a group consisting of flexible circuit board, printed circuit board, ceramic substrate and plastic substrate.

6. The photosensitive bonding package structure of claim 1, wherein the photosensitive device comprises a charge-coupled device (CCD) or a complementary metal-oxide-semiconductor (CMOS) device.

7. The photosensitive bonding package structure of claim 1, wherein the photosensitive device comprises an array of photodiodes disposed within the photosensitive region for receiving incident light that passes through the light incident area, converting light intensity level into electrical signals and transmitting the signals to the circuit substrate.

8. The photosensitive bonding package structure of claim 1, wherein the structure further comprises an external circuit board connected to the package via the outer contacts.

9. The photosensitive bonding package structure of claim 1, wherein the bumps have a stiffening structure disposed on the surface of the photosensitive device to surround the bumps.

10. The photosensitive bonding package structure of claim 1, wherein the structure further comprises a transparent plate disposed over the light incident area.

11. The package structure of claim 1, wherein the structure further comprises a transparent film disposed over the light incident area.

12. A photosensitive bonding package structure, comprising:
a photosensitive device having a photosensitive region with a plurality of bonding pads thereon, wherein the bonding pads are disposed on the surface of the photosensitive device around the photosensitive region;
a transparent substrate having a transparent region located above the photosensitive region, wherein the transparent substrate has a plurality of inner contacts and a plurality of corresponding outer contacts, the inner contacts are distributed around the transparent substrate and the inner contacts are electrically connected to the corresponding outer contacts; and
a plurality of bumps disposed between the transparent substrate and the photosensitive device, wherein each bump connects one of he bonding pads to a corresponding inner contact.

13. The photosensitive bonding package structure of claim 12, wherein the transparent substrate comprises a glass dielectric substrate.

14. The photosensitive bonding package structure of claim 12, wherein the transparent region is disposed in the central region of the transparent substrate.

15. A bonding package structure, comprising:
an optical pick-up device having a light source for emitting a beam of light, wherein the optical pick-up device has a plurality of bonding pads disposed around the light source;
a circuit substrate having a light incident area disposed over the light source, wherein the circuit substrate has a plurality of inner contacts and a plurality of corresponding outer contacts, the inner contacts are disposed around the circuit substrate and the inner contacts are electrically connected to the corresponding outer contacts; and
a plurality of bumps disposed between the circuit substrate and the optical pick-up device such that each bonding pad is electrically connected to one of the inner contacts.

16. The bonding package structure of claim 15, wherein the light incident area is disposed in the central region of the circuit substrate.

17. The bonding package structure of claim 15, wherein the inner contacts and the outer contacts are disposed on the same surface of the circuit substrate and the outer contacts are distributed close to the outer edge of the circuit substrate.

18. The bonding package structure of claim 15, wherein the inner contacts and the outer contacts are disposed on the top and the bottom surface of the circuit substrate and they are electrically connected through an internal circuit within the circuit substrate.

19. The bonding package structure of claim 15, wherein the circuit substrate is selected from a group consisting of flexible circuit board, printed circuit board, ceramic substrate and plastic substrate.

20. The bonding package structure of claim 15, wherein the structure further comprises an external circuit board connected to the package via the outer contacts.

21. The bonding package structure of claim 15, wherein the bumps have a stiffening structure disposed on the surface of the photosensitive device to surround the bumps.

22. The bonding package structure of claim 15, wherein the structure further comprises a transparent plate disposed over the light incident area.

23. The bonding package structure of claim 15, wherein the structure further comprises a transparent film disposed over the light incident area.
